(19) United States
(12) Patent Application Publication
(10) Pub. No.: US 2021/0406343 A1
(43) Pub. Date: Dec. 30, 2021

(54) SYSTEMS AND METHODS FOR INSTANTLY DE-DUPLICATING AUDIENCES USING DATA VISUALIZATION

(71) Applicant: CSC Holdings, LLC, Bethpage, NY (US)

(72) Inventors: Wael SABRA, Forest Hills, NY (US); Ganesh CHEEKATI, Jericho, NY (US)

(21) Appl. No.: 16/036,512

(22) Filed: Jul. 16, 2018

Related U.S. Application Data
(60) Provisional application No. 62/697,904, filed on Jul. 13, 2018.

(51) Int. Cl. G06F 17/30; G06F 3/0484

(52) U.S. Cl. CPC G06F 17/30991; G06F 3/0484; G06F 17/30994; G06F 17/30156

(57) ABSTRACT

An data de-duplication system (DDDS), method and applications thereof. The DDDS can permit a user to perform combinations and de-duplication of datasets, including complicated arrangements, having intended attributes. In some embodiments, the data de-duplication system includes a method for generating a query based on a population selected from a graphical user interface. The graphical user interface may present a visualization of available data on a client device. In some embodiments, the graphical user interface of the DDDS may include a visualization of the available datasets in a Euler or Venn diagram. In some embodiments, a query may be generated based on selected populations utilizing a logic interpreter.

### BACKGROUND

Logic operations may include operations that manipulate Boolean (i.e., true/false) values. However, analysis of complex sets of data may require stringing and nesting complicated logic operations. Moreover, a user may face difficulty generating complex operations and visualizing the data underlying these operations.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 illustrates a system for data de-duplication, according to an example embodiment.

FIG. 2 illustrates a flowchart of a method for data de-duplication, according to an example embodiment.

FIGS. 3A-3C illustrate an example of a graphical user interface of a data de-duplication system using data visualization.

FIGS. 4A-4B illustrate an example of a graphical user interface and logic interpretation of a data de-duplication system using data visualization.

FIG. 5A-5C illustrate an example of a process of data de-duplication using data visualization, according to an example embodiment.

FIG. 6 illustrates an example of an application of a data de-duplication system, according to an example embodiment.

FIG. 7 illustrates an example of an application of a data de-duplication system, according to an example embodiment.

FIG. 8 illustrates an example computing device, according to an example embodiment.

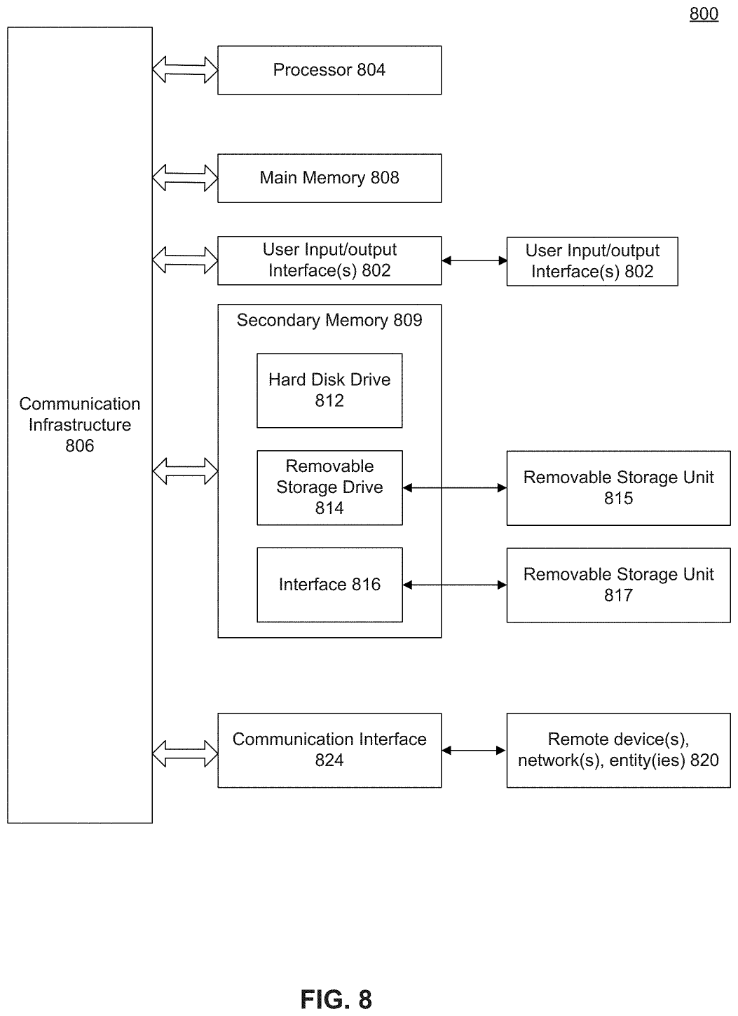

### DETAILED DESCRIPTION

### Overview

Forming logic operations on datasets and combinations of datasets can be an arduous, time and labor consuming process. A person performing such operations is expected to have a deep understanding of Boolean algebra or other mathematic logic, as well as an extensive understanding of all datum underlying the operation.

In many fields involving data arranged in diverse datasets, logic operations may be performed on large and complex arrangements of datasets. Such fields may include, but are not limited to, network management, advertisement delivery, analytics and data research, statistics, risk and actuarial management, and the like. Respective groups of data may be required to be combined and fragmented and recombined with each other in a very complicated manner.

The application of Boolean logic combined with set theory may involve both complicated arrangements of sets, and members thereof (in unions, intersections, complements or other dispositions) and complex logical formulations. Such problems can be exacerbated by a person having technical unfamiliarity with these applications and/or the data underlying intended operations. The present invention provides a Data Deduplication System to provide a user-friendly system and process of extracting, combining and/or deduplicating members of sets, including complex sets of data and convoluted combinations thereof.

For example, an advertisement campaign may require an audience selection process that is timely, accurate and precise to get the most return on the advertisement budget. A media buyer may wish to select consumer groups for targeting in an extensive but timely manner. However, the decision maker may not possess the technical or informational ability to complete this task. On the other hand, a technician proficient in Boolean logic may not have a prescient understanding of the consumer characteristics and group attributes that constitute available data.

It is increasingly difficult to reach consumers that relate uniformly by a generalized advertisement campaign. Demand is surging for interactive and/or programmatic ways to selectively reach consumers through advertisements and content. Therefore, it is essential for advertisers, media providers and others to discern, in or near real time, trends among consumers and viewers, including behavioral targeting and viewership tendencies. However, the decision maker, technician or other person involved in the campaign encounters the above-mentioned difficulties. As a result, systems for performing such logic and assembling data may be unsatisfactory and untimely for a campaign that requires large and complicated combinations of data.

Likewise, discerning concerns or trends in network performance and stability may require management of numerous systems or devices that have varying attributes. It may be difficult to express a logic operation on large and complex combinations over such data, particularly in a manner timely enough to ensure a stable network.

The systems and methods disclosed herein provide a user with near instantaneous visualization and de-duplication of data that may potentially involve large sets and/or complex combinations. De-duplication refers to a process of avoiding or removing duplicate or redundant members from a dataset. The data de-duplication system (DDDS) permits a user to perform combinations and de-duplication without necessarily possessing either a technical understanding of logic mathematics or a deep knowledge of the underlying data attributes. As a result, the user can acquire and utilize datasets having intended attributes and potentially real-time information with minimal delay and skill.

Provided herein are system, apparatus, article of manufacture, method, and/or computer program product embodiments, and/or combinations and sub-combinations thereof, for providing a data de-duplication system, and components and applications thereof. In some embodiments, the data de-duplication system includes a method for generating a query based on a population selected from a graphical user interface.

In some embodiments, the data de-duplication system may include the graphical user interface presented to a user on a client device. The graphical user interface may present a visualization of available data on a client device. The graphical user interface may present multiple datasets from multiple data collections and/or at least one subset of members of the multiple datasets, the multiple datasets and the at least one subset being selectable by a user of the DDDS through the graphical user interface.

In some embodiments, a graphical user interface of the DDDS may include a visualization of the available datasets in a Euler or Venn diagram. A user may select components of interest from the Euler or Venn diagram, including datasets, unions, intersections, complements and/or other parts thereof.

In some embodiments, the DDDS may include a method to provide a query results set to the user, the query results set including the query results. The query results set may be presented, for example, through the graphical user interface, as a separate delivery, or both. Alternatively or additionally, the query results set may be implemented as one dataset presented in the graphical user interface in a continued iteration of the DDDS.

In some embodiments, the query results set may alternatively or additionally be provided to a content delivery system that enables content delivery to members of one or more selected populations. In some embodiments, a content delivery system may enable delivery of advertisements to members of one or more selected populations.

In some embodiments, a query may be generated based on selected populations utilizing a logic interpreter. In a non-limiting example, a logic interpreter may translate the user's selections to a suitable means for querying data, such as a Boolean expression, SQL instruction or the like.

In some embodiments, a logic interpreter may be implemented by programmatic means, such as a software module, including software including a mathematical table, truth table, or the like. In some embodiments, a logic interpreter may be implemented by physical hardware, such as a microcontroller, FPGA, ASIC or other suitable device. In some embodiments, a logic interpreter may include both software and hardware.

In a non-limiting example, a data de-duplication system may deduplicate and provide data selected by a user from datasets, parts and/or combinations thereof, including audience members.

Further embodiments, features, and advantages of the disclosure, as well as the structure and operation of the various embodiments, are described in detail below with reference to accompanying drawings.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The foregoing description of specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

### A. Data De-duplication Systems and Methods

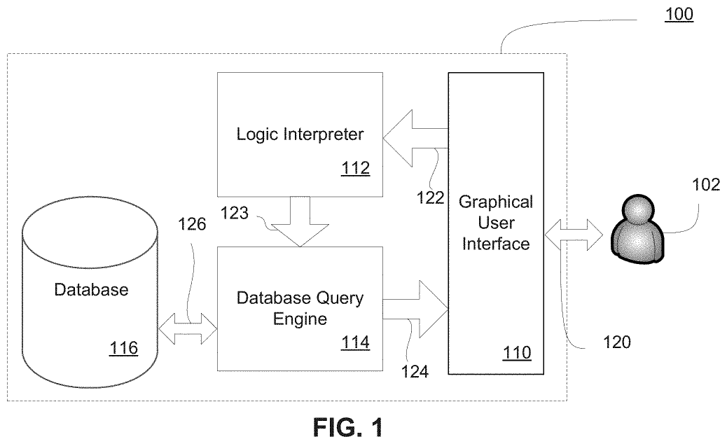

FIG. 1 is a diagram that illustrates components of a data de-duplication system (DDDS) 100 using a graphical user interface. DDDS 100 includes (not limited to) a graphical user interface (GUI) 110, a logic interpreter 112, a database query engine 114, and a database 116. DDDS 100 provides a graphical display of logic sets, allowing a user to select sets, parts and combinations thereof for analysis. Thereafter, as described below, the DDDS 100 includes a logic interpretation component configured to render a suitable expression for processing the selection. This allows the user to easily perform analysis on potentially complex sets and subsets with minimal technical knowledge of mathematical logic or set theory.

In data analytics and processing, decision making processes may be performed by parties that do not have sophisticated technical knowledge to assemble precise datasets and/or logic operations. Therefore, the present disclosure provides DDDS 100 that can include graphical user interface 110 and logic interpreter 112 to mitigate capabilities of a user 102 in assembling data queries potentially requiring complex logic or combinations of datasets.

More specifically, database 116 may be a single database or distributed at multiple sites, and may include a centralized data structure that stores data in one or more logical databases. DDDS 100 may first use a database query engine 114, which may execute an application, such as a structured query language (SQL) application to provide an example, to process a query 126.

Thereby, GUI 110 can include components having datasets populated by database query engine 114 from database 116. These datasets may be available to a user 102 as components (also referred to herein as “zones”) of GUI 110. Datasets may include mutually exclusive data members, or may include data members common to more than one available dataset. GUI 110 may further include, as components or zones, subsets of the available datasets, including subsets common to more than one available dataset (e.g., an intersection of two or more available datasets). In some embodiments, described in more detail below, datasets and subsets thereof may be disposed in a Euler or Venn diagram, for example. Through GUI 110, user 102 may select dataset components of interest 122 from the available components. These dataset components of interest 122 can be input to logic interpreter 112 by the user through GUI 110.

Logic interpreter 112 can translate the selected dataset components (or zones) of interest 122 into a logic expression 123 that may be resolved by database query engine 114. For example, logic interpreter 112 may include a table, such as a lookup table, which may be used to interpret attributes of each of selected dataset components of interest as a Boolean operation or other logic expression 123. Logic interpreter 112 can be configured to assemble logic expression 123 that may perform data de-duplication. As described in more detail below, GUI 110 can present multiple datasets and zones.

Database query engine 114 can process logic expression 123 to determine terms of query 126. The query results 124 may then be provided to the user 102 through GUI 110. The query results 124 can be used to populate datasets available to user 102 as components of GUI 110, as described above. In this case, query results 124 obtained based on each logic expression 123 can be used to re-populate some or all datasets available to a user 102 as components of GUI 110. Additionally, the query results can be provided to user 102 through GUI 110, not as components but as some other media that may be accessed by user 102 (such as a retrievable file or export).

Thus, DDDS 100 can permit user 102 to perform complex data operations, including querying, merging, and de-duplication of data, in a straightforward manner with minimal technical knowledge of dataset or logic assembly.

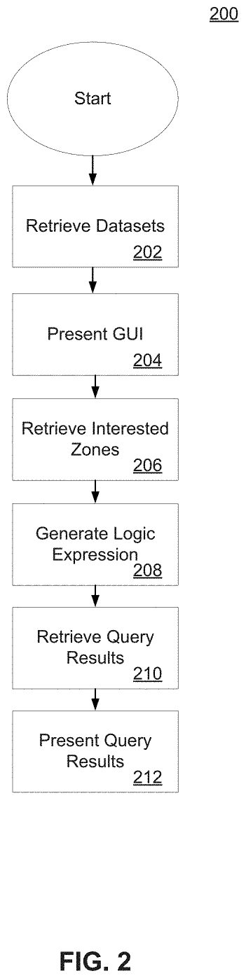

FIG. 2 illustrates a flow chart showing process 200 for performing data de-duplication using a graphical user interface (such as GUI 110). Method 200 is started in operation 202 by retrieving multiple datasets (also referred to herein as data collections) from a database. As described above, the datasets may include mutually exclusive data members, or may include data members common to more than one dataset. At operation 204, the retrieved datasets may be presented in the GUI to provide components that may be selected by a user. Likewise, datasets may be combined or partitioned, to form additional components such as intersections between datasets.

A user may then select components of interest among the available components (such components potentially including datasets, unions, intersections, complements and other parts thereof, as described above). The selected components of interest are input to a logic interpreter at operation 206. The logic interpreter parses or otherwise translates the input, including the selected components of interest, to generate a logic expression such as a Boolean or SQL operation, for example, at operation 208.

After a suitable logic expression is generated, a query based on the logic expression is submitted to the database at operation to retrieve query results at operation 210. The query results are presented to the user, through the GUI, as a communication separate from the GUI, or both, in operation 212. Furthermore, upon generating query results, one or more datasets may be populated or repopulated from the query results in operation 202.

As described in further detail below, a GUI may comprise datasets disposed in the form of a Euler or Venn diagram. Additional manners of arranging datasets in a GUI may be apparent to persons having ordinary skill in the art and are within the scope of this disclosure. Such additional arrangements may include, for example, disposing datasets for visualization and selection in a Kernaugh map, Carroll diagram, Hasse diagram, or the like.

B. Visualizing and De-Duplicating Data with a Euler or Venn Diagram

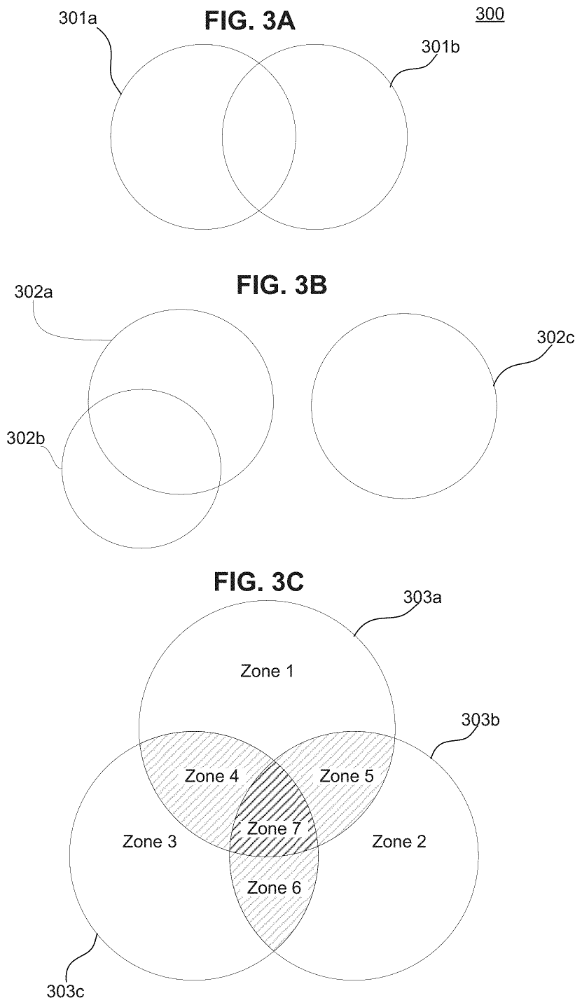

FIGS. 3A-3B are diagrams that illustrate a GUI 300 of a data de-duplication system or method, according to some embodiments. GUI 300 (which may correspond to one or more of GUIs described throughout this disclosure) can include, not limited to, a graphical diagram of datasets and parts thereof.

For example, FIG. 3A illustrates datasets 301a and 301b disposed in GUI 300 in the form of a Euler diagram or Venn diagram. In FIG. 3A, datasets 301a and 301b partially overlap such that there is an intersection. The intersection or overlap can indicate data members that may be common to both datasets 301a and 301b.

FIG. 3B illustrates another example of a GUI 300, including datasets 302a, 302b and 302c disposed in a Euler diagram. In FIG. 3B, datasets 302a and 302b partially overlap to form an intersection there between. Dataset 302c does not overlap with datasets 302a or 302b.

FIG. 3C illustrates a further example of a GUI 300, including datasets 303a, 303b and 303c disposed in a Euler or Venn diagram. In FIG. 3C, datasets 303a to 303c each partially overlap one another, such that multiple unions, complements and/or intersections may be formed. Specifically, in the GUI of FIG. 3C, the intersection of datasets 303a, 303b and 303c is indicated as zones 1 to 3, as shown. Furthermore, datasets 303a and 303c partially overlap to form an intersection in zone 4; datasets 303a and 303b partially overlap to form an intersection in zone 5; datasets 303b and 303c partially overlap to form an intersection in zone 6; and all datasets 303a to 303c partially overlap to form an intersection in zone 3. Thus, each of datasets 303a to 303c and zones 1 to zones 6 may constitute selectable components of GUI 300.

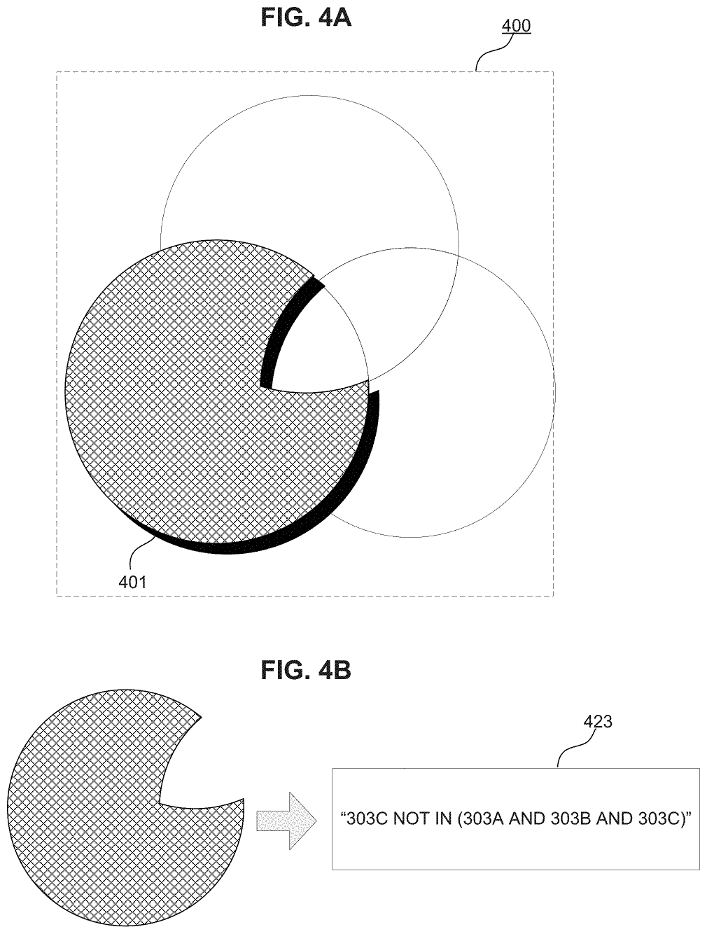

As described throughout this application, a user may select from any individual zone or combination of zones among datasets 303a, 303b, 303c disposed in GUI 300. FIGS. 4A and 4B illustrate a process of parsing a user's selection by a logic interpreter, such as logic interpreter 112 of FIG. 1. More specifically, FIG. 4A illustrates a GUI 400 including multiple datasets as described above. As shown in FIG. 4, a user may select from a user may select from any individual zone or combination of zones among the datasets, complements, intersections, unions and/or other parts. Here, selected components of interest 401 is highlighted.

With reference to FIG. 3C described above, selected components of interest 401 may correspond, for example, to zones 3, 4 and 6. Thus, a user may designate an interest in members of dataset 303c including intersections with datasets 303a or 303b, but excluding the intersection of datasets 303a, 303b and 303c (i.e., zone 7).

As described above, a user may select from the available components and submit the selection as an input. A logic interpreter, such as logic interpreter 112, can translate the user's selection into a suitable logic expression such as a Boolean operation, SQL expression, or the like. Here, the selection of zones 3, 4 and 6 may be translated by logic interpreter as logic expression 423, “303C NOT IN (303A AND 303B AND 303C).” That is, a logic interpreter can translate the user's selection as a logic instruction to include all members of dataset 303C that are not included in the intersection of all datasets.

In some embodiments, the GUI 300 may include datasets and components thereof that are sized according to the member population, e.g., an intersection having many members may be presented large relative to an intersection having less members to optimize data visualization.

In FIGS. 3A to 3C, multiple datasets may be illustrated as limited to two or three datasets. There is no limitation as to how many datasets may be disposed in a GUI 300. Thus, a GUI having additional sets in a Euler, Venn or other suitable diagram is within the scope of this disclosure, and practicable by a person of ordinary skill in the art.

However, also for ease of use and visualization, some embodiments may limit datasets available through a GUI to a maximum of three. Otherwise, the number of zones including unions and intersections may potentially increase at an exponential rate. Even where a GUI may contain a limit on available datasets (such as two or three), additional datasets may be further processed by continuing iterations of the above described systems and methods, according to some embodiments and as described in further detail below.

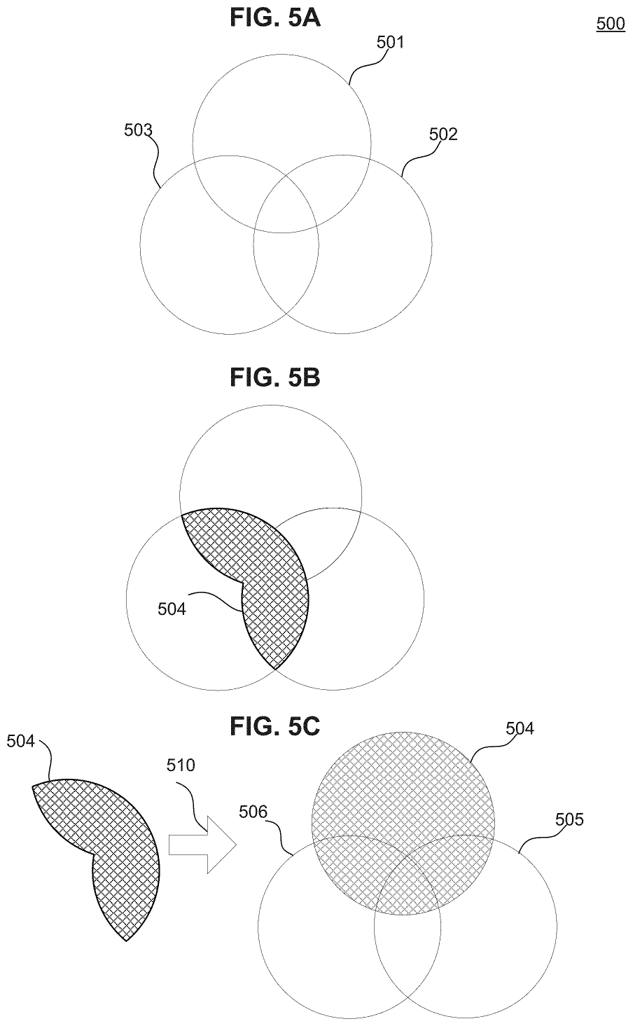

For example, as shown in FIGS. 5A-5C the query results based on a selection of components of interest may be relied on to populate or re-populate datasets comprised in a GUI, according to some embodiments. In FIG. 5A, GUI 500 includes datasets 501 to 503 in a first iteration. A user may be interested in components 504 including the intersection of datasets 501 and 503, the intersection of datasets 502 and 503, and the intersection of datasets 501, 502 and 503. That is, components 504 may correspond with equivalent zones 4, 6 and 7 illustrated in FIG. 3C. As shown in FIG. 5B, the user may select these zones, or components of interest 504 to be parsed in a logic expression and submitted to a database query engine (not shown) to perform data de-duplication.

In a second iteration shown in FIG. 5C, the members of components of interest 504 may be relied on to populate a dataset (e.g., in a reset or repopulation process 510) in a new Euler, Venn or other suitable diagram with datasets 505 and 506. Thus, the user can progress through additional datasets through this iterative process. As a result, the GUI 500 may be presented as many times as necessary to process sufficient datasets that may be of interest to a user while limiting the number of datasets simultaneously presented, for ease of visualization and use.

Accordingly, the user can perform operations on potentially complex combinations of data nearly instantaneously without possessing technical knowledge on assembling datasets or Boolean expressions that may otherwise be necessary.

### C. Examples of Systems for Data De-duplication Using Data Visualization to Target Content Delivery

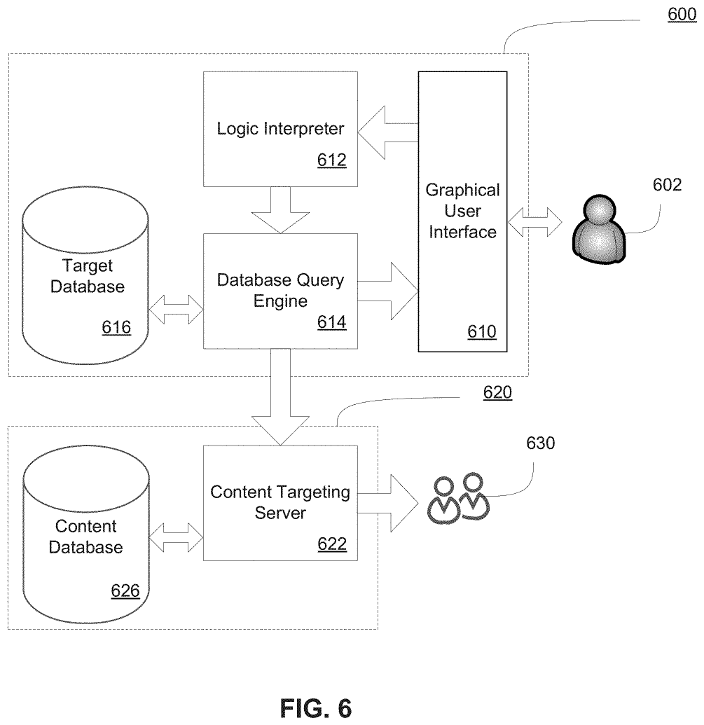

FIG. 6 is a diagram that illustrates components of DDDS 600 and a Content Delivery System 620. As shown in FIG. 6, DDDS 600 (which may correspond with a DDDS described in other embodiments) can include a GUI 610, a logic interpreter 612, a database query 614, and a target database 616. Content Delivery System 620 can include a content targeting server 622 and a content database 626. In some embodiments, DDDS and content delivery system may be combine in such manner to permit one or more users or agents thereof to select targets for content delivery from more than one datasets and execute delivery of content.

As described throughout this disclosure, DDDS 600 may present datasets on GUI 610, which may include mutually exclusive data members, or may include data members common to more than one dataset. The datasets retrieved and presented on GUI 610 may correspond with datasets 501 to 503 of FIGS. 5A to 5C, for example.

In the context of network management, datasets retrieved from database 616 may comprise unique identifiers corresponding to equipment, such as computer terminals, in a non-limiting example. Such datasets may respectively also comprise information such as system error information, operating system (OS) version, and processor speed. Thus, in GUI 610, datasets 501 to 503 may include information relating to network equipment and user 602 may be a person involved in the network management process, such as a network specialist.

In this example, dataset 501 may comprise members that have encountered a specific system error in the last thirty days. Dataset 502 may comprise members having a processor speed below some threshold value. Dataset 503 may comprise members that each have an OS missing some update or patch. User 602 may select components of interest through GUI 610. As shown in FIG. 5C, for example, the user 602 may select components of interest 504. That is, user 602 may select for de-duplication and processing, components 504 including the intersection of datasets 501 and 503, the intersection of datasets 502 and 503, and the intersection of datasets 501, 502 and 503. That is, components 504 may be selected corresponding to computer terminals that (1) have both the requisite system errors and an operating system that omits the critical patch; (2) have a processor speed below the threshold value and the obsolete OS; or (3) have all three attributes.

The selected components of interest 504 can be input to a logic interpreter 612. The logic interpreter translates the selected components of interest 504 to generate a logic expression such as a Boolean or SQL operation for processing by database query engine 614. Thereafter, the de-duplicated query results can be provided to the user though the GUI 610 or as a separate delivery, such as a file export. This content may comprise the unique identifiers constituting the query results, a count of the unique identifiers, or both. In this example, the de-duplicated data may be delivered to a content delivery system 620 for delivery to targets (which may be the computer terminals of interest, for example) 630. Thus, content targeting server 622 can receive the de-duplicated list of unique identifiers. The content targeting server can then retrieve the content intended for the targets from content database 626 and deliver it to targets 630. In this example, the content may include a patch or update to be delivered to computer terminals of interest.

Although DDDS 600 and content delivery system 620 are shown as separate systems, these elements may constitute integrated members of a single system and/or device. For example, components of DDDS 600 and content delivery system 620 may be disposed in a single device, separate devices or other suitable arrangement.

### D. Examples of Systems for Data De-duplication Using Data Visualization to Target Advertisement Delivery

An essential element of any advertising campaign is targeting it accurately and with precision. A process of directing advertisements to consumers may begin with deciding what audience a brand, advertiser or other party wishes to reach. A decision maker may wish to target specific audiences based on demographics. Demographics provides information on specific segments of the populace. This information may be nearly limitless and perpetually increasing. For example, demographic information may provide insights into consumers by informing the decision maker about their age, gender, marital status, home ownership, geographic location, political affiliation, and the like. Demographic information may include media content (e.g., television content, internet content, or the like) that a populace has viewed.

For example, a beverage brand may want to target consumers that include men who love sports and also women, two mutually exclusive groups. In some cases, the intended targets may be mutually exclusive, in other cases the target groups may have common members, requiring such audience lists to be combined and de-duplicated. Thus, the available data in targeting an advertising campaign can be expansive and complex. Generally, identifying lists of consumers may require a decision maker or other individual to understand Boolean algebra and have the ability to assemble datasets directed to target groups. A person involved in the process may not possess the technical knowledge to assemble data or combine logic in a meaningful way sufficient to identify an audience.

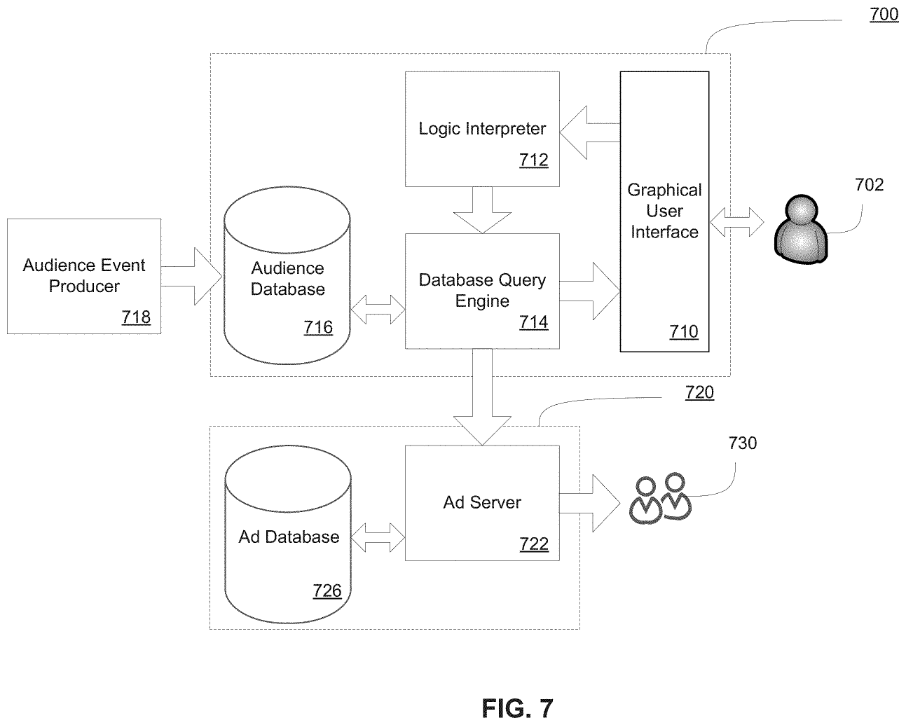

As shown in FIG. 7, in an embodiment DDDS 700 can enable the decision maker, such as user 702, to assemble a target audience in a straightforward manner, even without acquiring such ability. As described throughout above, DDDS 700 may present datasets on GUI 710, which may include mutually exclusive data members, or may include data members common to more than one dataset. User 702 may then obtain a de-duplicated target audience using DDDS 700 to be provided to an ad delivery system 720 to execute delivery of an advertisement to consumers 730.

In an example, the datasets retrieved and presented on GUI 710 may correspond with datasets 501 to 503 of FIGS. 5A to 5C. In the context of targeting audiences, datasets retrieved from audience database 716 may comprise unique identifiers corresponding to members (such as consumers). These datasets may also comprise information such as gender and content viewership, for example. Thus, in GUI 710, datasets 501 to 503 may include information relating to network equipment and user 702 may be a person involved in the advertisement process, such as a campaign decision-maker.

In this example, dataset 501 may comprise members who watched the season premiere of television show X. Dataset 502 may comprise members that have watched television network Y in the last thirty days. Dataset 503 may comprise women. User 702 may select components of interest through GUI 710. As described in other embodiments, and shown in FIG. 5C, for example, the user 702 may select components of interest 504. That is, user 702 may select for de-duplication and processing, components 504 including the intersection of datasets 501 and 503, the intersection of datasets 502 and 503, and the intersection of datasets 501, 502 and 503. That is, components 504 may be selected corresponding to women who have either watched the season premiere of television show X or, in the last thirty days, watched television network Y, or both.

The selected components of interest 504 can be input to and translated by a logic interpreter 712. The resulting logic expression may be processed by database query engine 714 and the combined, de-duplicated audience can be provided to user 702 though the GUI 710 or separate delivery. This content may comprise the unique identifiers constituting the query results, a count of the unique identifiers, or both and may then be provided, either directly or by the user 702 to advertisement delivery system 720. Alternatively, as described above user 702 may process components 504 in one or more additional iterations with other datasets, for further combining and de-duplication as described above.

In this example, the de-duplicated data may be delivered to an advertisement delivery system 720 for delivery to targets 730. For example, targets 730 may be content viewing devices, such as televisions or web browsers, for example. Thus, advertisement targeting server 722 can receive the de-duplicated list of unique identifiers. The advertisement targeting server can then retrieve the advertisement intended for the targets from an advertisement database 726 and deliver it to targets 730. In this example, the content may include an advertisement for a certain product or brand to be delivered to target audiences.

Optionally, DDDS 700 may be configured to communicate with one or more audience event producers 718, which may collect and aggregate audience events to be ingested to audience database 716. Such information may be collected and aggregated by a service provider, for example. The one or more audience event producers 718 communicate audience events to audience database 716, for example, in real time, on demand, or in accordance with some other suitable timing. In some embodiments, datasets and query results sets can be populated from real-time audience event data, such as television shows or networks viewed. Therefore, applications of DDDS 700 in some embodiments can include delivery of targeted advertisements based on data ingested in real time.

As described above, DDDS 700, advertisement delivery system 720 and audience event producers 718 are shown as separate systems but may be disposed in a single device or system. For example, components of DDDS 700, advertisement delivery system 720 and audience event producers 718 may be disposed in a single device, separate devices or other suitable arrangement.

### E. Example Computing Device Enabled for De-Duplicating Audiences Using Data Visualization

Computer system 800 includes one or more processors, such as processor 804. Processor 804 may comprise suitable logic, circuitry, dedicated circuits, and/or code that may enable processing data and/or controlling operations of computer system 800. Processor 804 can be a special purpose or a general purpose processor. Processor 804 may be connected to a communication infrastructure 806 (for example, a bus or network). Processor 804 may be enabled to provide control signals to the various other portions of computer system 800 via communication infrastructure 806, for example.

Computer system 800 also includes a main memory 808, and may also include a secondary memory 809. Secondary memory 809 may include, for example, a hard disk drive 812, a removable storage drive 814, and/or a memory stick. Removable storage drive 814 may comprise a floppy disk drive, a magnetic tape drive, an optical disk drive, a flash memory, or the like. The removable storage drive 814 reads from and/or writes to a removable storage unit 815 in a well-known manner. Removable storage unit 815 may comprise a floppy disk, magnetic tape, optical disk, etc. that is read by and written to by removable storage drive 814. As will be appreciated by persons skilled in the relevant art(s), removable storage unit 815 includes a computer usable storage medium having stored therein computer software and/or data.

In alternative implementations, secondary memory 809 may include other similar means for allowing computer programs or other instructions to be loaded into computer system 800. Such means may include, for example, a removable storage unit 817 and an interface 816. Examples of such means may include a program cartridge and cartridge interface (such as that found in video game devices), a removable memory chip (such as an EPROM, or PROM) and associated socket, and other removable storage units 817 and interfaces 816 that allow software and data to be transferred from the removable storage unit 817 to computer system 800.

Computer system 800 may also include a communications interface 824. Communications interface 824 allows software and data to be transferred between computer system 800 and external devices (such as a server of one or more embodiments as described above) 820. Communications interface 824 may include a modem, a network interface (such as an Ethernet card), a communications port, a PCMCIA slot and card, or the like. Software and data transferred via communications interface 824 are in the form of signals that may be electronic, electromagnetic, optical, or other signals capable of being received by communications interface 824. These signals are provided to communications interface 824 via a communications path 810. Computer system 800 may be configured to enable communications between computer system 800 and external devices such as server 820 (such as an advertisement delivery server, for example).

In this document, the terms “computer program medium” and “computer usable medium” are used to generally refer to media such as removable storage unit 815, removable storage unit 817, and a hard disk installed in hard disk drive 812. Computer program medium and computer usable medium can also refer to memories, such as main memory 808 and secondary memory 809, which can be memory semiconductors (e.g., DRAMs, etc.). These computer program products are means for providing software to computer system 800.

Computer programs (also called computer control logic) are stored in main memory 808 and/or secondary memory 809. Computer programs may also be received via communications interface 824. Such computer programs, when executed, enable computer system 800 to implement the embodiments as discussed herein. In particular, the computer programs, when executed, enable processor 804 to implement the disclosed processes, such as the steps in the method 200 of FIG. 2, as discussed above. Accordingly, such computer programs represent controllers of the computer system 800. Where the embodiments are implemented using software, the software may be stored in a computer program product and loaded into computer system 800 using removable storage drive 814, interface 816, hard drive 812 or communications interface 824. This can be accomplished, for example, through the use of general-programming languages (such as C or C++). The computer program code can be disposed in any known computer-readable medium including semiconductor, magnetic disk, or optical disk (such as, CD-ROM, DVD-ROM). As such, the code can be transmitted over communication networks including the Internet and internets. It is understood that the functions accomplished and/or structure provided by the systems and techniques described above can be represented in a core (such as a processing-unit core) that is embodied in program code and may be transformed to hardware as part of the production of integrated circuits. This can be accomplished, for example, through the use of hardware description languages (HDL) including Verilog HDL, VHDL, Altera HDL (AHDL) and so on, or other available programming and/or schematic-capture tools (such as, circuit-capture tools).

Embodiments are also directed to computer program products including software stored on any non-transitory computer useable medium. Such software, when executed in one or more data processing device, causes a data processing device(s) to operate as described herein. Embodiments employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The accompanying drawings, which are incorporated herein and form part of the specification, illustrate the embodiments and, together with the description, further serve to explain the principles of the embodiments and to enable a person skilled in the pertinent art to make and use the embodiments. The embodiments will be described with reference to the accompanying drawings. Generally, the drawing in which an element first appears is typically indicated by the leftmost digit(s) in the corresponding reference number.

The breadth and scope of the present invention should not be limited by any of the above-described embodiments, but should be defined only in accordance with the following claims and their equivalents.

1. A computer-implemented method for delivering content by a content delivery system, the computer-implemented method comprising:
retrieving a plurality of datasets that are associated with a plurality of populations, at least two datasets from among the plurality of datasets having a data member that is common to more than one dataset from among the plurality of datasets;
providing a graphical display of the plurality of data datasets as a plurality of graphical zones to a client device, at least one graphical zone from among the plurality of graphical zones being associated with the data member that is common to more than one dataset;
retrieving a selection of the at least one graphical zone that is associated with a population from among the plurality of populations from the client device;
translating the selected at least one graphical zone into a logic expression that logically identifies the data member that is common to more than one dataset from among the plurality of datasets;
retrieving the data member that is common to more than one dataset from the plurality of datasets using the logic expression, the logic expression being generated such that the data member that is common to more than one dataset is not duplicated in the retrieved data member that is common to more than one dataset; and
presenting the retrieved data member that is common to more than one dataset to the content delivery system to enable delivery of the content to the population from among the plurality of populations.

2. The computer-implemented method of claim 1, wherein the providing the graphical display comprises:
presenting a graphical user interface on the client device; and
graphically displaying the plurality of data datasets as the plurality of graphical zones on the graphical user interface, and
wherein the at least one graphical zone is graphically displayed as being at least one intersection between the at least two datasets having the data member that is common to more than one dataset from among the plurality of datasets.

3. The computer-implemented method of claim 2, wherein the graphically displaying the plurality of data datasets as the plurality of graphical zones in the graphical user interface comprises:
graphically displaying a Venn diagram illustrating the plurality of datasets and the intersection between the at least two datasets.

4. The computer-implemented method of claim 2, wherein the graphically displaying the plurality of data datasets as the plurality of graphical zones in the graphical user interface comprises:
graphically displaying a Euler diagram illustrating the plurality of datasets and the intersection between the at least two datasets.

5. The computer-implemented method of claim 1, wherein the translating comprises:
generating the logic expression to include at least one combinatorial operation to logically identify the data member that is common to more than one dataset from among the plurality of datasets.

6. (canceled)

7. The computer-implemented method of claim 1, wherein the plurality of datasets includes at least one dataset having a plurality of unique identifiers and media viewing information related to the plurality of unique identifiers.

8. A computer system for delivering content by a content delivery system, the computer system comprising:
a memory that stores a plurality of datasets that are associated with a plurality of populations, at least two datasets from among the plurality of datasets having a data member that is common to more than one dataset from among the plurality of datasets; and
one or more processors, configured to execute instructions stored in the memory, the instructions, when executed by the one or more processors, configuring the one or more processors to:
cause a client device to a graphically display the plurality of data datasets as a plurality of graphical zones, at least one graphical zone from among the plurality of graphical zones being associated with the data member that is common to more than one dataset,
retrieve a selection of the at least one graphical zone that is associated with a population from among the plurality of populations from the client device,
translate the selected at least one graphical zone into a logic expression that logically identifies the data member that is common to more than one dataset from among the plurality of datasets stored in the memory,
retrieve the data member that is common to more than one dataset from the plurality of datasets stored in the memory using the logic expression, the logic expression being generated such that the data member that is common to more than one dataset is not duplicated in the retrieved data member that is common to more than one dataset, and
present the retrieved data member that is common to more than one dataset to the content delivery system to enable delivery of the content to the population from among the plurality of populations.

9. The computer system of claim 8, wherein the instructions, when executed by the one or more processors, configure the one or more processors to:
cause the client device to present a graphical user interface on the client device; and
cause the client device to graphically display the plurality of data datasets as the plurality of graphical zones on the graphical user interface,
wherein the client device is configured to graphically display the at least one graphical zone on the graphical user interface as being at least one intersection between the at least two datasets having the data member that is common to more than one dataset from among the plurality of datasets.

10. The computer system of claim 9, wherein the instructions, when executed by the one or more processors, configure the one or more processors to:
cause the client device to graphically display the plurality of data datasets as a Venn diagram illustrating the plurality of datasets and the intersection between the at least two datasets.

11. The computer system of claim 9, wherein the instructions, when executed the one or more processors, configure the one or more processors to:
cause the client device to graphically display the plurality of data datasets as a Euler diagram illustrating the plurality of datasets and the intersection between the at least two datasets.

12. (canceled)

13. The computer system of claim 8, wherein the plurality of datasets includes at least one dataset having a plurality of unique identifiers and media viewing information related to the plurality of unique identifiers.

14. A client device for delivering content by a content delivery system, the client device comprising:
a memory that stores instructions; and
one or more processors configured to execute the instructions stored in the memory, the instructions, when executed by the one or more processors, configuring the one or more processors to:
retrieve a plurality of datasets that are associated with a plurality of populations, at least two datasets from among the plurality of datasets having a data member that is common to more than one dataset from among the plurality of datasets,
graphically display the plurality of data datasets as a plurality of graphical zones, at least one graphical zone from among the plurality of graphical zones being associated with the data member that is common to more than one dataset,
retrieve a selection of the at least one graphical zone that is associated with a population from among the plurality of populations,
translate the selected at least one graphical zone into a logic expression that logically identifies the data member that is common to more than one dataset from among the plurality of datasets,
retrieve the data member that is common to more than one dataset from the plurality of datasets from the plurality of datasets using the logic expression, the logic expression being generated such that the data member that is common to more than one dataset is not duplicated in the retrieved data member that is common to more than one dataset, and
present the retrieved data member that is common to more than one dataset to the content delivery system to enable delivery of the content to the population from among the plurality of populations.

15. The client device of claim 14, wherein the instructions, when executed by the one or more processors, further configure the one or more processors to:
present a graphical user interface; and
graphically display the plurality of data datasets as the plurality of graphical zones on the graphical user interface, and
wherein the at least one graphical zone is graphically displayed as being at least one intersection between the at least two datasets having the data member that is common to more than one dataset from among the plurality of datasets.

16. The client device of claim 15, wherein the instructions, when executed by the one or more processors, further configure the one or more processors to:
graphically display a Venn diagram illustrating the plurality of datasets and the intersection between the at least two datasets.

17. The client device of claim 15, wherein the instructions, when executed by the one or more processors, further configure the one or more processors to:
graphically display a Euler diagram illustrating the plurality of datasets and the intersection between the at least two datasets.

18. (canceled)

19. The client device of claim 14, wherein the plurality of datasets includes at least one dataset having a plurality of unique identifiers and media viewing information related to the plurality of unique identifiers.

20. (canceled)
